(19) United States
(12) Patent Application Publication
(10) Pub. No.: US 2016/0099945 A1
(43) Pub. Date: Apr. 7, 2016

(54) DNS SECURITY EXTENSIONS FOR EMULATED APPLICATIONS

(71) Applicants: Susan C Webb, Roseville, MN (US); John A Peters, Roseville, MN (US); Robert L. Bergerson, Roseville, MN (US); Jason C. Schultz, Roseville, MN (US)

(72) Inventors: Susan C Webb, Roseville, MN (US); John A Peters, Roseville, MN (US); Robert L. Bergerson, Roseville, MN (US); Jason C. Schultz, Roseville, MN (US)

(73) Assignee: UNISYS CORPORATION, Blue Bell, PA (US)

(21) Appl. No.: 14/508,280

(22) Filed: Oct. 7, 2014

(51) Int. Cl. H04L 29/06; H04L 29/12

(52) U.S. Cl. CPC H04L 63/101; H04L 61/1511; H04L 63/08

(57) ABSTRACT

The non-emulated interface may determine whether the domain-name-to-be-resolved resides in a zone on a list of secured zones. If so, the DNS query may be processed by a non-emulated interface in the host environment. The non-emulated interface may determine whether the domain-name-to-be-resolved resides in a zone on a list of secured zones. If so, the DNS query may be performed by the non-emulated interface using DNSSEC. DNS resolutions that do not pass the security checks may fail while DNS resolutions that pass the security checks will be returned to the customer.

### FIELD OF THE DISCLOSURE

The instant disclosure relates to computer systems. More specifically, this disclosure relates to methods and systems for DNS security extensions for customer domain name zones.

### BACKGROUND

Applications executing in an emulated environment may be unaware of the hardware carrying out the instructions executed by the applications or the infrastructure behind the hardware. The emulated environment allows the execution, on a first hardware system, of applications designed for a different second hardware system. Thus, the emulated environment improves compatibility between disparate hardware and software systems. However, because an application in the emulated environment may have limited interaction with the hardware and infrastructure executing the application, the application may be unable to control certain aspects of the execution of the applications. For example, an application executing in an emulated environment may not be aware of the capability of authenticating domain name resolutions available through DNSSEC extensions. The use of authenticated domain names may reduce user apprehension about security breaches of proprietary and/or sensitive information. Thus, a solution is desired where an application in an emulated environment may benefit from added security to DNS communications without needing to make changes to their existing applications.

### SUMMARY

The security of DNS communications between customer applications and one or more central DNS servers may be improved by using DNS security (DNSSEC) extensions to authenticate specific zones of a customer's domain name tree. The DNSSEC extensions may be implemented in a host environment of the emulated environment without modifying applications executing in the emulated environment. Thus, DNS communications, such as domain name resolutions, from the application in the emulated environment may be authenticated without modification to the application. The host environment may implement the additional security and authentication for DNS communications, such as by performing DNS queries with DNSSEC extensions and checking an authentication of the domain name resolution before providing the results back to the application. Thus, DNS communications from the application may be secured through modifications to the host environment. This may be advantageous, for example, when changes to the application executing in the emulated environment would require extensive review and testing before implementation. Instead, modifications may be made in the host environment to provide DNSSEC capability for the application in the emulated environment.

According to one embodiment, a method may comprise receiving, at a non-emulated interface, a DNS query from a program executed in an emulated environment and comparing, by the non-emulated interface, a domain name associated with the DNS query to a list of secure domain names. The method may further comprise determining, by the non-emulated interface, that the domain name is listed on the list of secure domain names and sending an instruction to one or more DNS servers to authenticate the domain name associated with the DNS query. The method may further comprise receiving an indication from the one or more DNS servers whether the domain name has been authenticated, and sending a DNS query result to the program.

In some embodiments, the program receives the DNS query from a customer application, wherein the customer application creates one or more secure zones of a customer's domain names. The one or more security files may be created and stored on the one or more DNS servers corresponding to the one or more secure zones. The list of secure domain names may be created based on contents of the one or more security files.

In some embodiments, the DNS query result may comprise an answer to the DNS query when the non-emulated interface receives an indication that the domain name has been authenticated. In some embodiments, the DNS query result may comprise an error code when the non-emulated interface receives an indication that the domain name has not been authenticated. In some embodiments, the DNS query result may comprise an indication that the domain name cannot be found when the non-emulated interface determines that the domain name associated with the DNS query is not listed on the list of secure domain names.

According to another embodiment, a computer program product may include a non-transitory computer-readable medium comprising code to perform the steps receiving, at a non-emulated interface, a DNS query from a program executed in an emulated environment and comparing, by the non-emulated interface, a domain name associated with the DNS query to a list of secure domain names. The medium may also include code to perform the steps of determining, by the non-emulated interface, that the domain name is listed on the list of secure domain names and sending an instruction to one or more DNS servers to authenticate the domain name associated with the DNS query. The medium may also include code to perform the steps of receiving an indication from the one or more DNS servers whether the domain name has been authenticated and sending a DNS query result to the program.

According to yet another embodiment, an apparatus may include a storage device, a memory, and a processor coupled to the memory and storage device. The processor may be configured to execute the steps of receiving, at a non-emulated interface, a DNS query from a program executed in an emulated environment and comparing, by the non-emulated interface, a domain name associated with the DNS query to a list of secure domain names. The processor may be further configured to execute the steps of determining, by the non-emulated interface, that the domain name is listed on the list of secure domain names and sending an instruction to one or more DNS servers to authenticate the domain name associated with the DNS query. The processor may be further configured to execute the steps of receiving an indication from the one or more DNS servers whether the domain name has been authenticated and sending a DNS query result to the program.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating a computer network according to one embodiment of the disclosure.

FIG. 2 is a block diagram illustrating a computer system according to one embodiment of the disclosure.

FIG. 3 is a block diagram illustrating a server hosting an emulated software environment for virtualization according to one embodiment of the disclosure.

FIG. 4 is a flow chart illustrating a process of imposing security on a domain name zone (or zones) according to one embodiment of the disclosure.

FIG. 5 is a flow chart illustrating a process of determining the security level of a domain name according to one embodiment of the disclosure.

### DETAILED DESCRIPTION

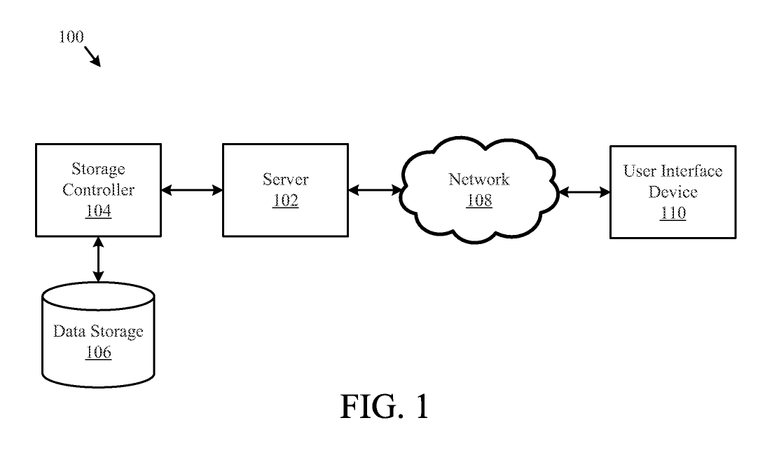

FIG. 1 illustrates one embodiment of a system 100 for creating and implementing DNS security extensions for domain name zones according to one embodiment of the disclosure. The system 100 may include a server 102, a data storage device 106, a network 108, and a user interface device 110. In a further embodiment, the system 100 may include a storage controller 104, or a storage server configured to manage data communications between the data storage device 106 and the server 102 or other components in communication with the network 108. In an alternative embodiment, the storage controller 104 may be coupled to the network 108.

In one embodiment, the user interface device 110 is referred to broadly and is intended to encompass a suitable processor-based device such as a desktop computer, a laptop computer, a personal digital assistant (PDA) or tablet computer, a smartphone or other mobile communication device having access to the network 108. In a further embodiment, the user interface device 110 may access the Internet or other wide area or local area network to access a web application or web service hosted by the server 102 and may provide a user interface for enabling a user to enter or receive information, such as retrieving logged data regarding DNS authentication failures.

The network 108 may facilitate communications of data between the server 102 and the user interface device 110. The network 108 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

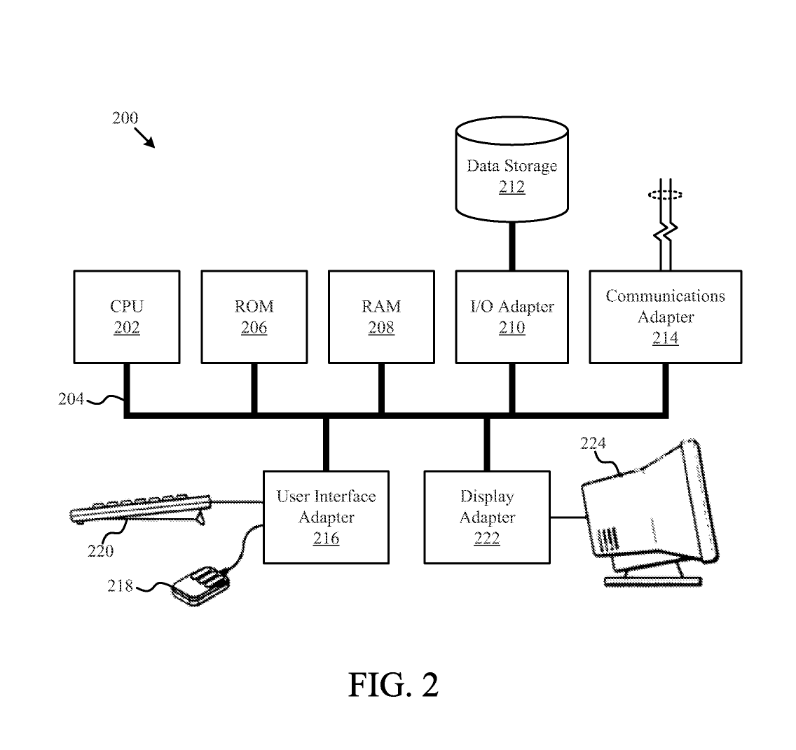

FIG. 2 illustrates a computer system 200 adapted according to certain embodiments of the server 102 and/or the user interface device 110. The central processing unit (“CPU”) 202 is coupled to the system bus 204. The CPU 202 may be a general purpose CPU or microprocessor, graphics processing unit (“GPU”), and/or microcontroller. The present embodiments are not restricted by the architecture of the CPU 202 so long as the CPU 202, whether directly or indirectly, supports the operations as described herein. The CPU 202 may execute the various logical instructions according to the present embodiments.

The computer system 200 may also include random access memory (RAM) 208, which may be synchronous RAM (SRAM), dynamic RAM (DRAM), synchronous dynamic RAM (SDRAM), or the like. The computer system 200 may utilize RAM 208 to store the various data structures used by a software application. The computer system 200 may also include read only memory (ROM) 206 which may be PROM, EPROM, EEPROM, optical storage, or the like. The ROM may store configuration information for booting the computer system 200. The RAM 208 and the ROM 206 hold user and system data, and both the RAM 208 and the ROM 206 may be randomly accessed.

The computer system 200 may also include an input/output (I/O) adapter 210, a communications adapter 214, a user interface adapter 216, and a display adapter 222. The I/O adapter 210 and/or the user interface adapter 216 may, in certain embodiments, enable a user to interact with the computer system 200. In a further embodiment, the display adapter 222 may display a graphical user interface (GUI) associated with a software or web-based application on a display device 224, such as a monitor or touch screen.

The I/O adapter 210 may couple one or more storage devices 212, such as one or more of a hard drive, a solid state storage device, a flash drive, a compact disc (CD) drive, a floppy disk drive, and a tape drive, to the computer system 200. According to one embodiment, the data storage 212 may be a separate server coupled to the computer system 200 through a network connection to the I/O adapter 210. The communications adapter 214 may be adapted to couple the computer system 200 to the network 108, which may be one or more of a LAN, WAN, and/or the Internet. The user interface adapter 216 couples user input devices, such as a keyboard 220, a pointing device 218, and/or a touch screen (not shown) to the computer system 200. The display adapter 222 may be driven by the CPU 202 to control the display on the display device 224. Any of the devices 202-222 may be physical and/or logical.

The applications of the present disclosure are not limited to the architecture of computer system 200. Rather the computer system 200 is provided as an example of one type of computing device that may be adapted to perform the functions of the server 102 and/or the user interface device 110. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 200 may be virtualized for access by multiple users and/or applications. For example, the computer system 200 may be emulated in a host environment of server 102, such that applications may execute as if being run on the computer system 200 when they are actually being executed by the hardware of the server 102.

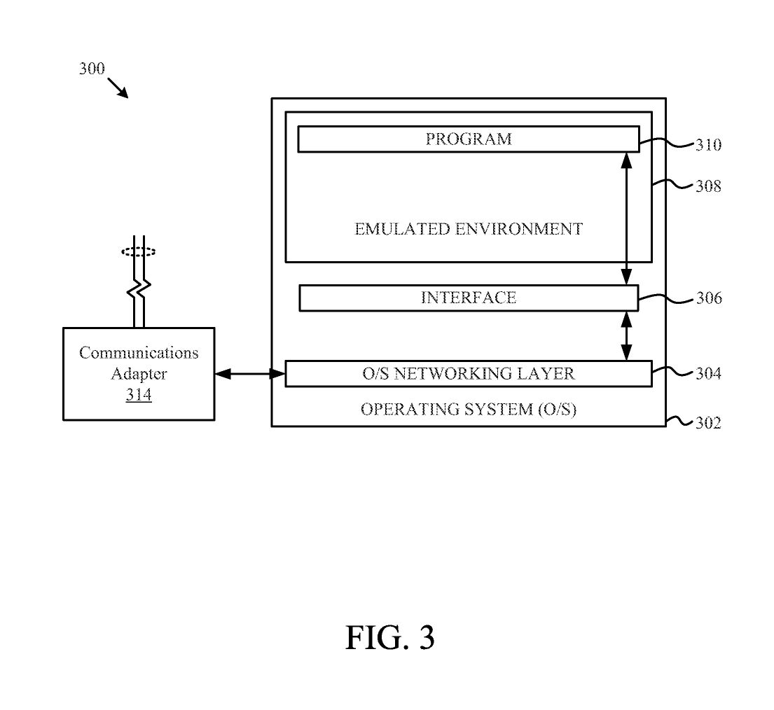

FIG. 3 is a block diagram illustrating a server hosting an emulated software environment for virtualization according to one embodiment of the disclosure. An operating system 302 executing on a server includes drivers for accessing hardware components, such as a networking layer 304 for accessing the communications adapter 314. The operating system 302 may be, for example, Linux or Windows. An emulated environment 308 in the operating system 302 executes a program 310, such as Communications Platform (CPComm) or Communications Platform for Open Systems (CPCommOS). The program 310 accesses the networking layer 304 of the operating system 302 through a non-emulated interface 306, such as extended network input output processor (XNIOP). The non-emulated interface 306 translates requests from the program 310 executing in the emulated environment 308 for the networking layer 304 of the operating system 302.

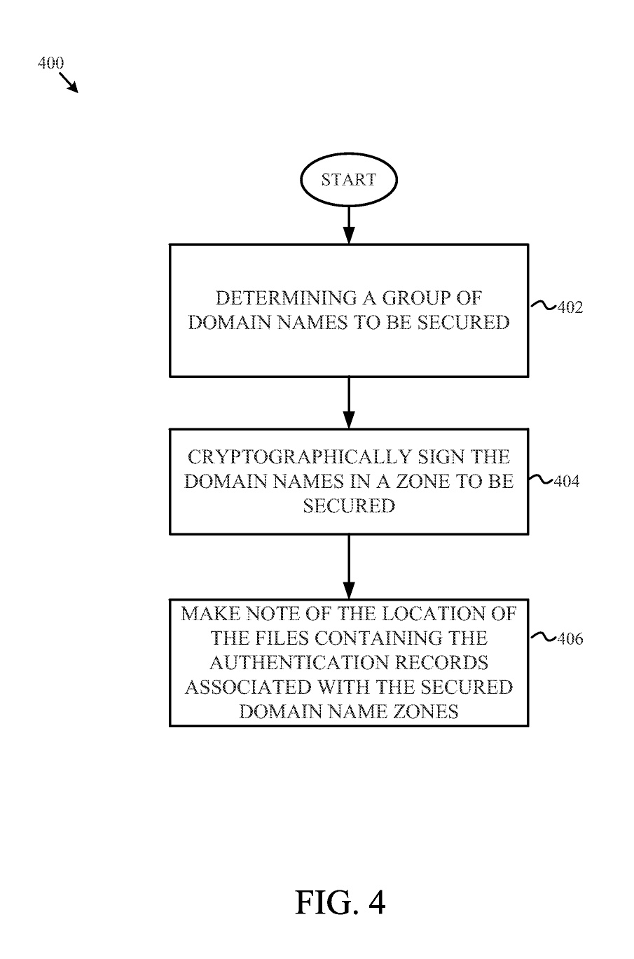

FIG. 4 is a flow chart illustrating a process of imposing security on a domain name zone (or zones) according to one embodiment of the disclosure. To accomplish this, the customer may use DNSSEC. DNSSEC may be a collection of new resource records and DNS protocol modifications that may add data origin authentication and data integrity to their DNS tree. To achieve this functionality, DNSSEC may modify standard API calls. In one embodiment, DNSSEC may be implemented on systems based on the System Architecture Interface Layer Control Center (SAILCC). In some embodiments. DNSSEC may implement one or more signed zones. A zone is a set of domain names and their associated resource records. Domain names in a secure zone are associated with a cryptographically-generated digital signature.

Method 400 may include, at block 402, a customer determining one or more groups of domain names from their domain name tree to be secured. This step may be performed by a network administrator during a configuration of DNS servers. The administrator may perform this task using SAILCC or other suitable platform.

At block 404, method 400 may continue at block 402 with cryptographically signing domain names in the zone or zones to be secured. Method 400 may continue at block 406 with making note of the location of the files containing the authentication records associated with the secured domain name zones. In one embodiment, block 406 may include copying or transferring the files containing the authentication records associated with the secured domain name zones. Signing the zones on a DNS server results in the creation of Delegation Signer (DS) records on the DNS server. These DS records may be included in a DSSET file transportable to other computing systems, block 406 indicates that the administrator may make note of the names of these files. For example, the DSSET file may be copied to the computing system running a host environment for the application. The DSSET file may also contain one or more images in a “secure-zone” or “public-key” format. A modification may be made to SAILCC code to gather the DSSET files for the zones and store them in a file on one or more servers. In some embodiments, the records may be stored in a root file and the server may be a Mariner system. The application may communicate with the central server via CPCommOS.

The schematic flow chart diagram of FIG. 4 is generally set forth as a logical flow chart diagram. As such, the depicted order and labeled steps are indicative of one aspect of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

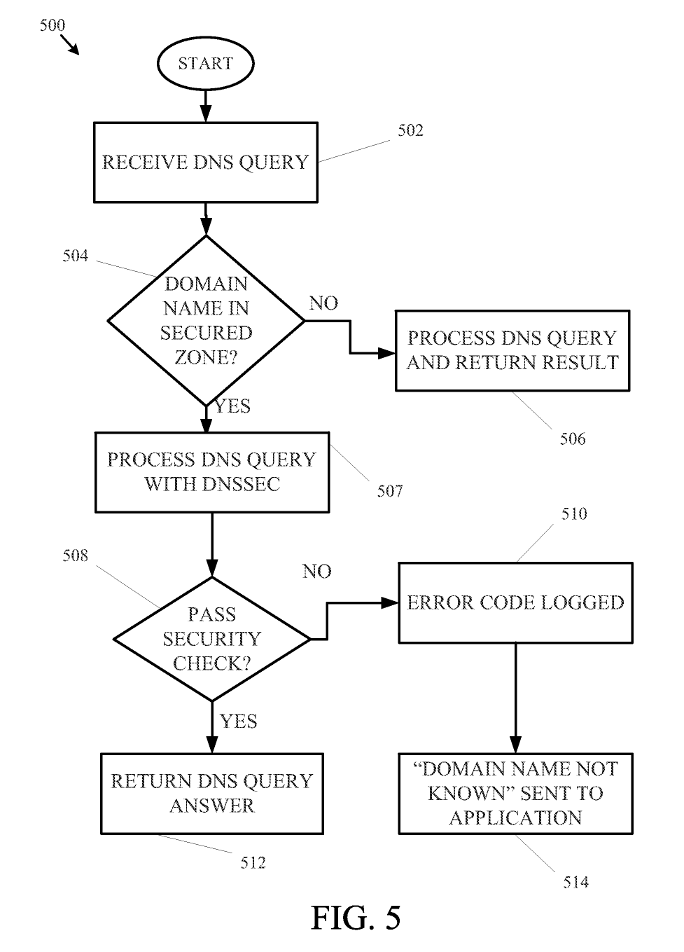

FIG. 5 is a flow chart illustrating a process of determining the security level of a domain name according to one embodiment of the disclosure. Method 500 may be performed within a host environment of an emulated environment, such as a network input/output processor including the Linux XNIOP. The XNIOP code may be modified to enable it to perform the steps of method 500. Method 500 may commence at block 502 with network input/output (I/O) processor receiving a DNS query from an application executing in the emulated environment. A network input/output (I/O) processor in the host environment may receive the DNS query containing one or more domain names to be resolved. Upon receipt of the DNS query, the network I/O processor may determine whether the domain name is secured, as shown in block 504. The determination may be performed by the network I/O processor extracting the names contained in the secure zones from the DSSET files and/or the root file to create a list of secure domain names. The network I/O processor may then compare the domain names contained in the DNS query with the list of secure domain names to determine if the domain names in the DNS query are secured. If the domain name is not secured, then the DNS query is processed normally at block 506 and the result of the DNS query returned to the application. If the DNS query at block 506 results in a failure to resolve a domain name, then a “domain name not known” message may be returned to the application.

If the domain name in the DNS query is found in the list of secure domain names, the network I/O processor may continue to block 507. The network I/O processor, at block 507, may request DNSSEC authentication on the DNS query by setting flags on a request passed to the DNS server, such as the “DNSSEC-OK” and “authentication-desired” bits. These flags may signal the one or more DNS servers to authenticate and verify the information related to the domain names. In response to block 507, the DNS server may return the requested information and indicate whether the authentication and verification checks succeeded.

At block 508, the network I/O processor may determine whether the response to the DNS query indicated that the DNS resolution passed security checks. If the DNS server indicates that security checks were failed, the network I/O processor may send an error code to the host environment at block 510. This step may be performed in a Linux auxiliary status parameter where the error code is sent to emulated environment and logged. In one embodiment, the error code may not be sent to the application. After the host environment logs the error code, it may send a response, at block 514, to the application indicating that the domain name is not known. An administrator may later check the CPCommOS log to analyze the error codes. If the security checks succeeded at block 508, XNIOP may return the DNS query answer to the application in the host environment at block 512. If the DNS query at block 507 resulted in a failure to resolve a domain name, then a “domain name not known” message may be returned to the application.

The schematic flow chart diagram of FIG. 5 is generally set forth as a logical flow chart diagram. As such, the depicted order and labeled steps are indicative of one aspect of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Those of skill would appreciate that the various illustrative logical blocks, modules, circuits, and algorithm steps described in connection with the disclosure herein may be implemented as electronic hardware, computer software stored on a computing device and executed by one or more processing devices, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

In some embodiments, the techniques or steps of a method described in connection with the aspects disclosed herein may be embodied directly in hardware, in software executed by a processor, or in a combination of the two. In some aspects of the disclosure, any software module, software layer, or thread described herein may comprise an engine comprising firmware or software and hardware configured to perform aspects of the described herein. In general, functions of a software module or software layer described herein may be embodied directly in hardware, or embodied as software executed by a processor, or embodied as a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium may be coupled to the processor such that the processor can read data from, and write data to, the storage medium. In the alternative, the storage medium may be integral to the processor. The processor and the storage medium may reside in an ASIC. The ASIC may reside in a user device. In the alternative, the processor and the storage medium may reside as discrete components in a user device.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

While the aspects of the disclosure described herein have been described with reference to numerous specific details, one of ordinary skill in the art will recognize that the aspects of the disclosure can be embodied in other specific forms without departing from the spirit of the aspects of the disclosure. Thus, one of ordinary skill in the art would understand that the aspects described herein are not to be limited by the foregoing illustrative details, but rather are to be defined by the appended claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving, at a non-emulated interface, a DNS query from a program executed in an emulated environment;
comparing, by the non-emulated interface, a domain name associated with the DNS query to a list of secured zones comprising secured domain names;
determining, by the non-emulated interface, whether the domain name resides in a zone on the list of secured zones; and
when the domain name resides in a zone on the list of secured zones, performing the steps comprising:
sending an instruction to one or more DNS servers to resolve the DNS query and to authenticate the domain name associated with the DNS query;
receiving a response comprising an indication from the one or more DNS servers whether the domain name has been authenticated; and
sending a DNS query result to the program based, at least in part, on the received indication.

2. The method of claim 1, wherein the DNS query result comprises an answer to the DNS query when the non-emulated interface receives an indication that the domain name has been authenticated.

3. The method of claim 1, wherein the DNS query result comprises an error code when the non-emulated interface receives an indication that the domain name has not been authenticated.

4. The method of claim 1, further comprising, when the domain name is not listed on the list of secure domain names, performing the steps comprising:
sending an instruction to one or more DNS servers to resolve the DNS query;
receiving a response comprising a domain name resolution; and
sending a DNS query result to the program based, at least in part, on the received domain name resolution.

5. The method of claim 1, wherein the step of determining comprises retrieving at least a portion of the list of secure domains names from a DSSET file.

6. The method of claim 1, wherein the step of sending an instruction to the one or more DNS servers comprises setting a flag in a DNS query sent to the one or more DNS servers.

7. The method of claim 1, wherein the DNS query result sent to the program comprises an indication that the domain name cannot be found when the non-emulated interface determines that the domain name associated with the DNS query resides in the list of secured zones and the indication from the one or more DNS servers indicates the domain name was not authenticated.

8. A computer program product, comprising:
a non-transitory computer-readable medium comprising instructions which, when executed by a processor of a computing system, cause the processor to perform the steps of:
receiving, at a non-emulated interface, a DNS query from a program executed in an emulated environment;
comparing, by the non-emulated interface, a domain name associated with the DNS query to a list of secured zones comprising secured domain names;
determining, by the non-emulated interface, whether the domain name resides in a zone on the list of secured zones; and
when the domain name resides in a zone on the list of secured zones, performing the steps comprising:
sending an instruction to one or more DNS servers to resolve the DNS query and to authenticate the domain name associated with the DNS query;
receiving a response comprising an indication from the one or more DNS servers whether the domain name has been authenticated; and
sending a DNS query result to the program based, at least in part, on the received indication.

9. The computer program product of claim 8, wherein the DNS query result comprises an answer to the DNS query when the non-emulated interface receives an indication that the domain name has been authenticated.

10. The computer program product of claim 8, wherein the DNS query result comprises an error code when the non-emulated interface receives an indication that the domain name has not been authenticated.

11. The computer program product of claim 8, wherein the medium further comprises instructions to, when the domain name is not listed on the list of secure domain names, perform the steps comprising:
sending an instruction to one or more DNS servers to resolve the DNS query;
receiving a response comprising a domain name resolution; and
sending a DNS query result to the program based, at least in part, on the received domain name resolution.

12. The computer program product of claim 8, wherein the step of determining comprises retrieving at least a portion of the list of secure domains names from a DSSET file.

13. The computer program product of claim 8, wherein the step of sending an instruction to the one or more DNS servers comprises setting a flag in a DNS query sent to the one or more DNS servers.

14. The computer program product of claim 8, wherein the DNS query result sent to the program comprises an indication that the domain name cannot be found when the non-emulated interface determines that the domain name associated with the DNS query resides in the list of secured zones and the indication from the one or more DNS servers indicates the domain name was not authenticated.

15. An apparatus, comprising:
a memory; and
a processor coupled to the memory, wherein the processor is configured to execute the steps of:
receiving, at a non-emulated interface, a DNS query from a program executed in an emulated environment;
comparing, by the non-emulated interface, a domain name associated with the DNS query to a list of secured zones comprising secured domain names;
determining, by the non-emulated interface, whether the domain name resides in a zone on the list of secured zones; and
when the domain name resides in a zone on the list of secured zones, performing the steps comprising:
sending an instruction to one or more DNS servers to resolve the DNS query and to authenticate the domain name associated with the DNS query;
receiving a response comprising an indication from the one or more DNS servers whether the domain name has been authenticated; and
sending a DNS query result to the program based, at least in part, on the received indication.

16. The apparatus of claim 15, wherein the DNS query result comprises an answer to the DNS query when the non-emulated interface receives an indication that the domain name has been authenticated.

17. The apparatus of claim 15, wherein the DNS query result comprises an error code when the non-emulated interface receives an indication that the domain name has not been authenticated.

18. The apparatus of claim 15, wherein the processor is further configured to execute the steps comprising:
sending an instruction to one or more DNS servers to resolve the DNS query;
receiving a response comprising a domain name resolution, and
sending a DNS query result to the program based, at least in part, on the received domain name resolution.

19. The apparatus of claim 15, wherein the step of determining comprises retrieving at least a portion of the list of secure domains names from a DSSET file.

20. The apparatus of claim 15, wherein the step of sending an instruction to the one or more DNS servers comprises setting a flag in a DNS query sent to the one or more DNS servers.

21. The apparatus of claim 15, wherein the DNS query result sent to the program comprises an indication that the domain name cannot be found when the non-emulated interface determines that the domain name associated with the DNS query resides in the list of secured zones and the indication from the one or more DNS servers indicates the domain name was not authenticated.
